(19) United States
(12) Patent Application Publication
(10) Pub. No.: US 2020/0226260 A1
(43) Pub. Date: Jul. 16, 2020

(54) FIRMWARE RESILIENCY MECHANISM

(71) Applicant: Intel Corporation, Santa Clara, CA (US)

(72) Inventors: Nivedita Aggarwal, Portland, OR (US); Anoop Mukker, Folsom, CA (US); Michael Berger, Jerusalem (IL); Karunakara Kotary, Portland, OR (US); Arijit Chattopadhyay, Folsom, CA (US); Rajesh Poornachandran, Portland, OR (US)

(73) Assignee: Intel Corporation, Santa Clara, CA (US)

(21) Appl. No.: 16/832,147

(22) Filed: Mar. 27, 2020

(51) Int. Cl. G06F 21/57; G06F 21/56; G06F 11/14

(52) U.S. Cl. CPC G06F 21/572; G06F 21/575; G06F 2201/865; G06F 11/1433; G06F 2221/033; G06F 21/566

(57) ABSTRACT

An apparatus to facilitate firmware resiliency in a computer system platform is disclosed. The apparatus comprises a first non-volatile memory to store primary firmware for a computer system platform, a second non-volatile memory to store a firmware copy of the primary firmware and a resiliency hardware, coupled to the first non-volatile memory via the system fabric, to detect unauthorized access to the primary firmware and restore the primary firmware stored in the first non-volatile memory with the firmware copy.

### BACKGROUND OF THE DESCRIPTION

A system on chip (SOC) is an integrated circuit that integrates all components of a computer or other electronic system. These components include a central processing unit (CPU), memory, input/output (IO) ports and secondary storage, which are all included on a single substrate or microchip. Additionally, SOCs enable the integration of third party components via a standardized on-die interconnect protocol. However, the addition of such components may lead to security vulnerabilities.

### BRIEF DESCRIPTION OF THE DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only typical embodiments and are therefore not to be considered limiting of its scope, for the disclosure may admit other equally effective embodiments.

FIG. 1 illustrates one embodiment of a computing device.

FIGS. 2A-2C illustrate embodiments of a platform.

FIG. 3 illustrates yet another embodiment of a platform.

FIGS. 4A-4D is a flow diagram illustrating one embodiment of a resiliency process.

FIG. 5 illustrates one embodiment of a schematic diagram of an illustrative electronic computing device.

### DETAILED DESCRIPTION

In the following description, numerous specific details are set forth to provide a more thorough understanding. However, it will be apparent to one of skill in the art that the embodiments may be practiced without one or more of these specific details. In other instances, well-known features have not been described in order to avoid obscuring the embodiments.

In embodiments, a mechanism is provided to facilitate firmware resiliency in a computer system platform. In such embodiments, a second non-volatile memory is added to the computer system platform to store a firmware copy of primary firmware stored in a first non-volatile memory. A resiliency agent detects unauthorized access to the primary firmware and incase of unauthorized changes, restores the primary firmware with the firmware copy. In further embodiments, the first and second non-volatile memories are isolated. In such embodiments, the resiliency agent is coupled to the first non-volatile memory via a system fabric and coupled to the second non-volatile memory via the an out of band side channel

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

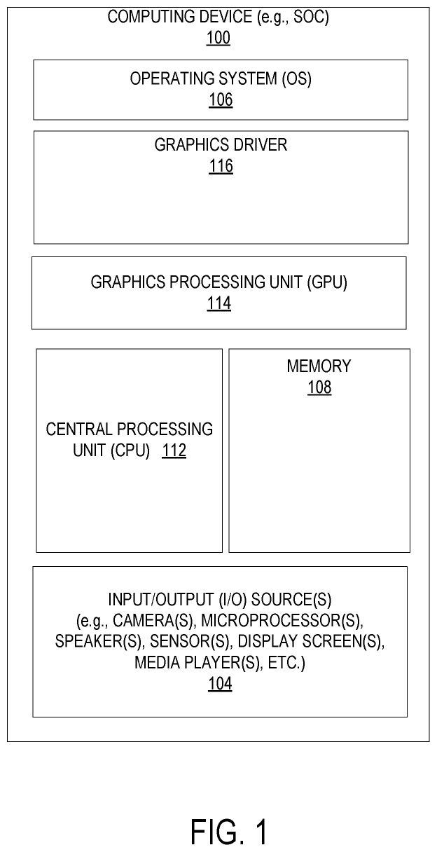

FIG. 1 illustrates one embodiment of a computing device 100. According to one embodiment, computing device 100 comprises a computer platform hosting an integrated circuit (“IC”), such as a system on a chip (“SoC” or “SOC”), integrating various hardware and/or software components of computing device 100 on a single chip. As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

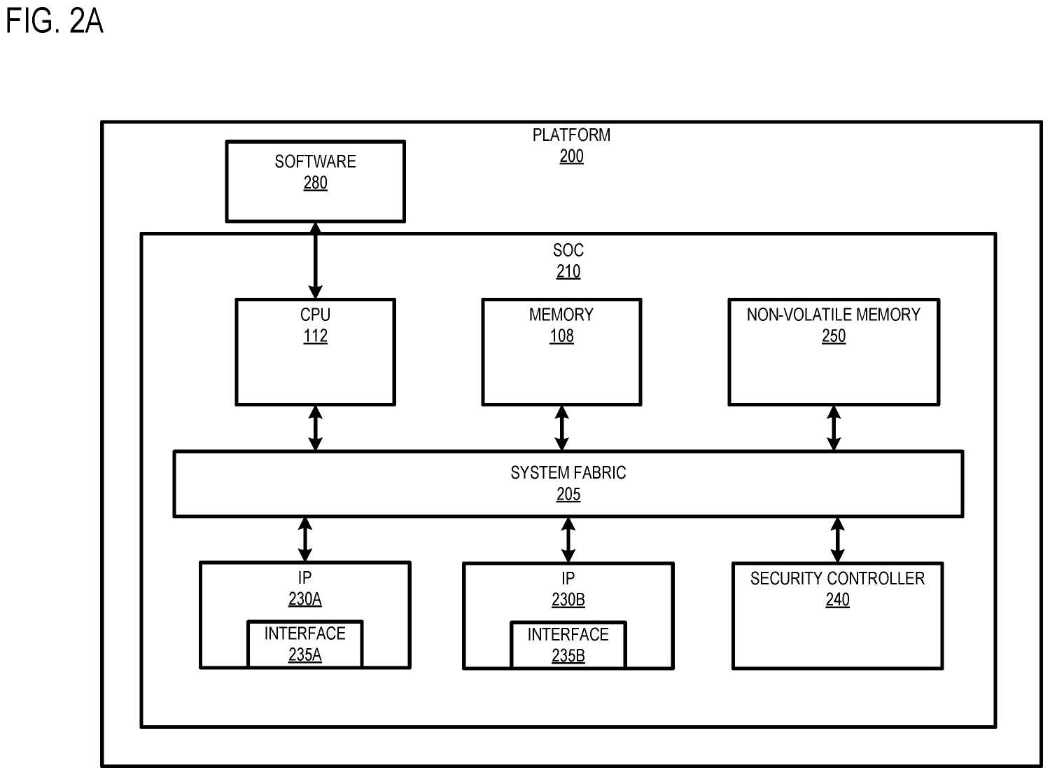

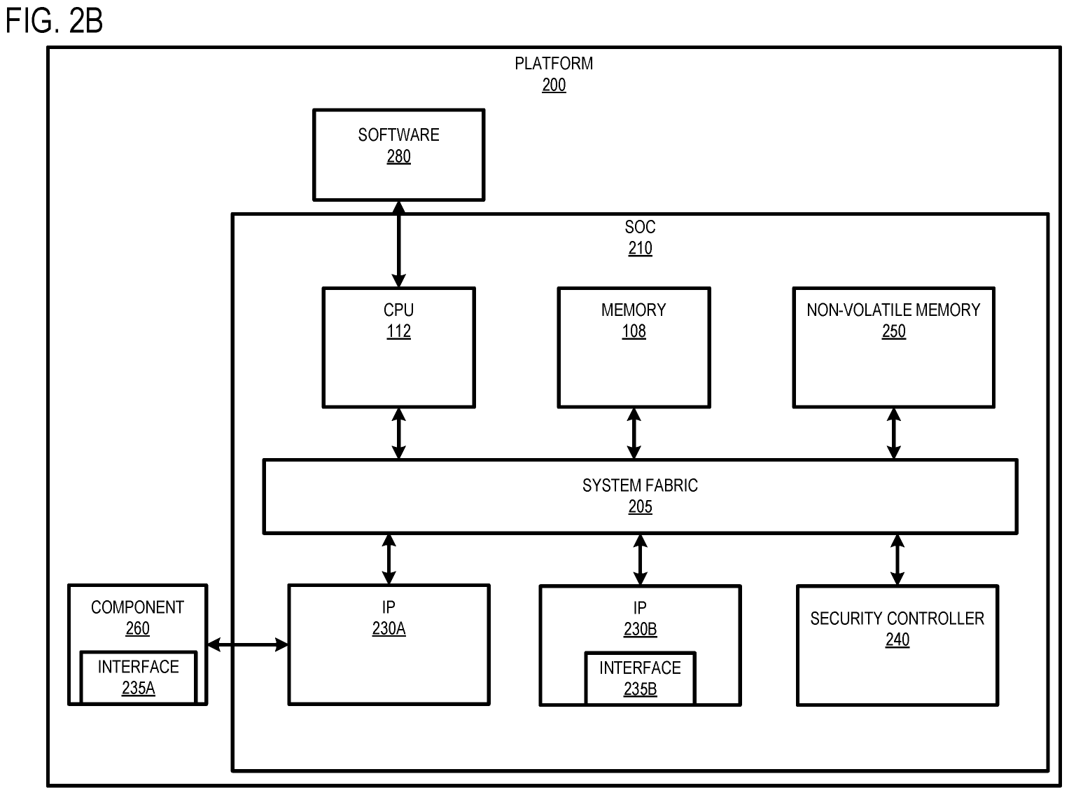

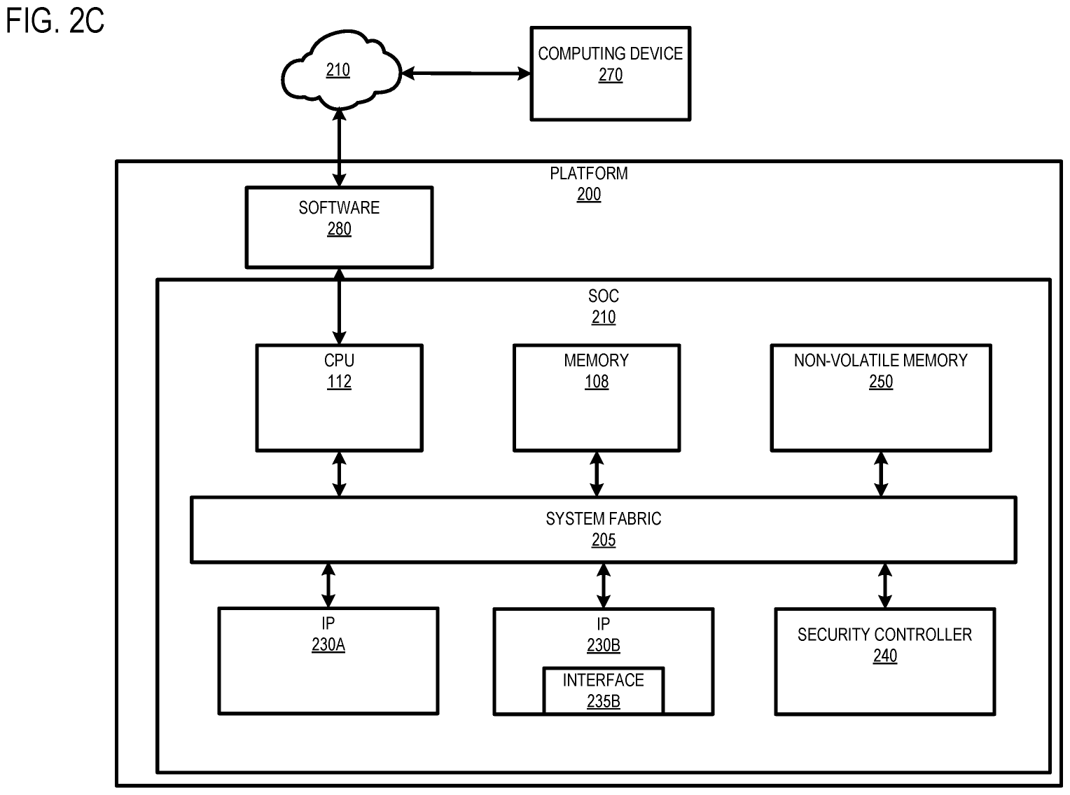

FIGS. 2A-2C illustrate embodiments of a platform 200 including a SOC 210 similar to computing device 100 discussed above. As shown in FIG. 2A, platform 200 includes SOC 210 communicatively coupled to one or more software components 250 via CPU 112. Additionally, SOC 210 includes other computing device components (e.g., memory 108) coupled via a system fabric 205. In one embodiment, system fabric 205 comprises an integrated on-chip system fabric (IOSF) to provide a standardized on-die interconnect protocol for coupling interconnect protocol (IP) agents 230 (e.g., IP blocks 230A and 230B) within SOC 210. In such an embodiment, the interconnect protocol provides a standardized interface to enable third parties to design logic such as IP agents to be incorporated in SOC 210.

According to embodiment, IP agents 230 may include general purpose processors (e.g., in-order or out-of-order cores), fixed function units, graphics processors, I/O controllers, display controllers, etc. In such an embodiment, each IP agent 230 includes a hardware interface 235 to provide standardization to enable the IP agent 230 to communicate with SOC 210 components. For example, in an embodiment in which IPA agent 230 is a third party visual processing unit (VPU), interface 235 provides a standardization to enable the VPU to access memory 108 via fabric 205.

SOC 210 also includes a security controller 240 that operates as a security engine to perform various security operations (e.g., security processing, cryptographic functions, etc.) for SOC 210. In one embodiment, security controller 240 comprises an IPA agent 230 that is implemented to perform the security operations. Further, SOC 210 includes a non-volatile memory 250. Non-volatile memory 250 may be implemented as a Peripheral Component Interconnect Express (PCIe) storage drive, such as a solid state drives (SSD) or Non-Volatile Memory Express (NVMe) drives. In one embodiment, non-volatile memory 250 is implemented to store the platform 200 firmware. For example, non-volatile memory 250 stores boot (e.g., Basic Input/Output System (BIOS)) and device (e.g., IP agent 230 and security controller 240) firmware.

FIG. 2B illustrates another embodiment of platform 200 including a component 270 coupled to SOC 210 via IP 230A. In one embodiment, IP 230A operates as a bridge, such as a PCIe root port, that connects component 260 to SOC 210. In this embodiment, component 260 may be implemented as a PCIe device (e.g., switch or endpoint) that includes a hardware interface 235 to enable component 260 to communicate with SOC 210 components. FIG. 2C illustrates yet another embodiment of platform 200 including a computing device 270 coupled to platform 200 via a cloud network 210. In this embodiment, computing device 270 comprises a cloud agent that is provided access to SOC 210 via software 280.

Currently, attacks by malicious agents on platform 200 firmware (e.g., non-volatile memory 250, IP agents 230, security controller 240, etc.) are on the rise. Such firmware attacks result in privacy data leaks, system downtime that negatively impact businesses. Additionally, these attacks have resulted in the National Institute of Standards and Technology releasing a Special Publication for Platform Firmware Resiliency titled the NIS T SP800-193, which set firmware resiliency guidelines and requirements.

Typical implementations of firmware resiliency include a secondary firmware copy installed on a platform flash component. With multiple firmware components on the platform, and all OEMs striving to meet the compliance, platform flash needs have grown, thus increasing overall cost of the OEM Platforms. Currently most client platform firmware on systems can fit within a 32 MB serial peripheral interface (SPI) flash. However, adding resiliency is causing the need for a second flash device on the system, which in some cases increases cache size to 64 MB.

Other existing solutions, use a method that allows to Download and Execute Firmware from an external storage drive like a USB thumb drive. This solution has the problem that it requires user intervention to recover the system and takes away OEM control over the Recovery image.

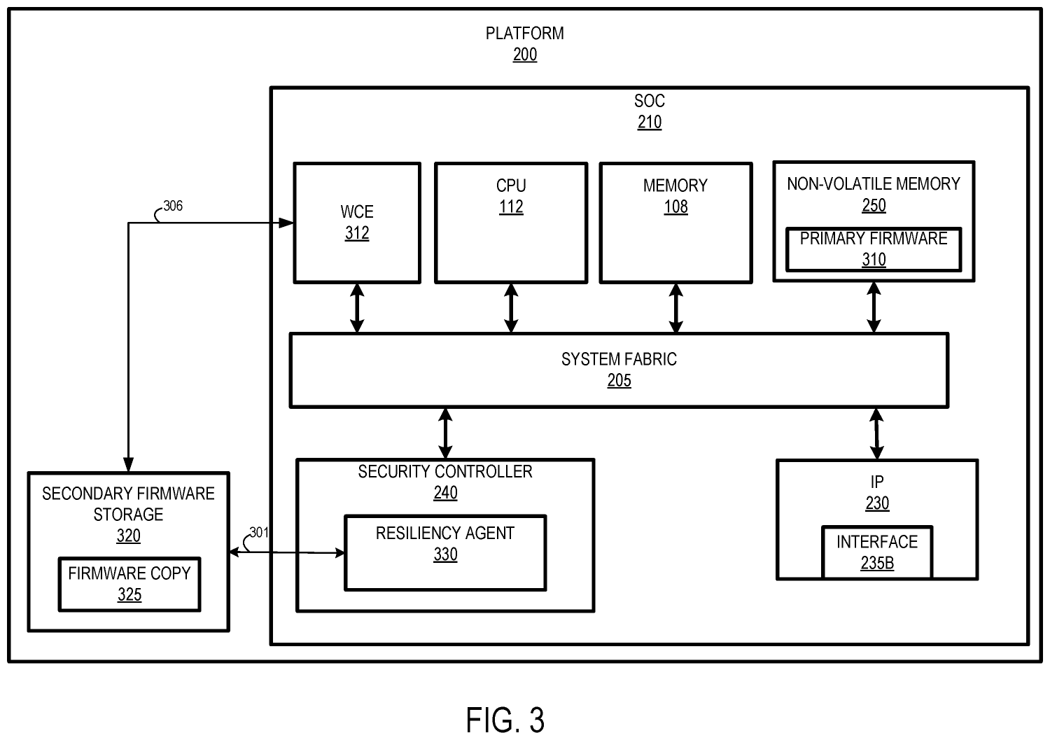

According to one embodiment, additional firmware storage is added to platform 200 to provide resiliency augmentation. In such an embodiment, the additional firmware stores a secondary copy of different platform firmware components required to meet the resiliency requirements inside of a boot partition of block storage. FIG. 3 illustrates yet another embodiment of platform 200 including secondary firmware storage 320 and a resiliency agent 330 included in security controller 240.

As mentioned above, non-volatile memory 250 is implemented as a storage for platform firmware (e.g., primary firmware 310 (or resiliency target)). In one embodiment, resiliency support is provided for primary firmware 310 stored in non-volatile memory 250. As defined herein, platform firmware resiliency describes security mechanisms for protecting platform against unauthorized changes, detecting unauthorized changes that occur and recovering from attacks. In a further embodiment, the primary firmware 310 is restored in order to bring back the system to a bootable state upon detection of corruption and/or failure.

Secondary firmware storage 320 (or resiliency firmware source) is implemented to store a backup (or secondary) copy of the primary firmware (or firmware copy) 325 stored in non-volatile memory 250. In one embodiment, the backup firmware is used to restore the firmware stored in non-volatile memory 250 upon detecting unauthorized access to primary firmware 310 (e.g., firmware attacked or corrupted). In yet a further embodiment, requirements are implemented at secondary firmware storage 320 to prevent the attacks or failures that may occur at primary firmware 310. Such requirements include, writes to secondary firmware storage 320 being totally isolated from primary firmware 310; secondary firmware storage 320 having higher levels of protection than non-volatile memory 250; secondary firmware storage 320 being used and accessed only during recovery flows and when updated in a secure manner, and not during normal boot; and secondary firmware storage 320 only being updated by an authenticated update, and in case of some corruption, being restored by a root of trust for the region.

In embodiments, secondary firmware storage 320 may be implemented via universal flash storage (UFS) or NVMe. In further embodiments, secondary firmware storage 320 may be implemented as block storage or remote cloud storage (e.g., via cloud network 210 shown in FIG. 2C) that is accessed via an out of band (OOB) interface. In still further embodiments, the source of secondary firmware storage 320 may be dynamically selected (e.g., from UFS, NVMe, block storage, cloud storage, etc.). In such embodiments, one of these sources may be selected based on a configuration policy for replacing local secondary firmware storage 320 upon a determination that the local secondary firmware storage 320 has been corrupted.

Resiliency agent 330 provides a root of trust for recovery primary firmware 310. In one embodiment, resiliency agent 330 performs a verification of the primary firmware 310 during a boot up of platform 200 to detect whether there has been unauthorized access to primary firmware 310. In such an embodiment, restores the primary firmware 310 using a firmware copy 325 stored at secondary firmware storage 320 upon detecting corruption of primary firmware 310 failure (e.g., via system fabric 205) and. In a further embodiment, resiliency agent 330 restores the primary firmware 310 by retrieving the firmware copy 325 from secondary firmware storage 320 (e.g., via OOB side channel 301) and overwriting the existing primary firmware 310 at non-volatile memory 250 with the firmware copy (e.g., via system fabric 205). Although described as being included in security controller 240, resiliency agent 330 may be implemented in other embodiments as stand-alone agent.

According to one embodiment, platform 200 also includes a Wireless Credentials Exchange (WCE) controller 312 coupled to fabric 205. Additionally, WCE controller 312 is coupled to secondary firmware storage 320 via a radio frequency interface (e.g., radio frequency identification (RFID)) 306. In such an embodiment, WCE controller 312 is a RFID controller implemented to track, as well as lock, secondary firmware storage 320 to prevent unauthorized access. In a further embodiment, WCE controller 312 may lock portions of secondary firmware storage 320 may be permanently locked to prevent modification.

According to one embodiment, WCE controller 312 is implemented to provision secondary firmware storage 320 with credentials and configurable security policies. In yet a further embodiment, WCE controller 312 may be wirelessly configured and upgraded via radio frequency (RF) to dynamically configure platform 200 for platform resiliency behavior at specific geographic premises (e.g., public vs. private vs. hybrid cloud). WCE controller 312 provides a non-network based mechanism to activate and de-activate security policies in real-time. Accordingly, WCE controller 312 is not vulnerable to network compromises or attacks over a network.

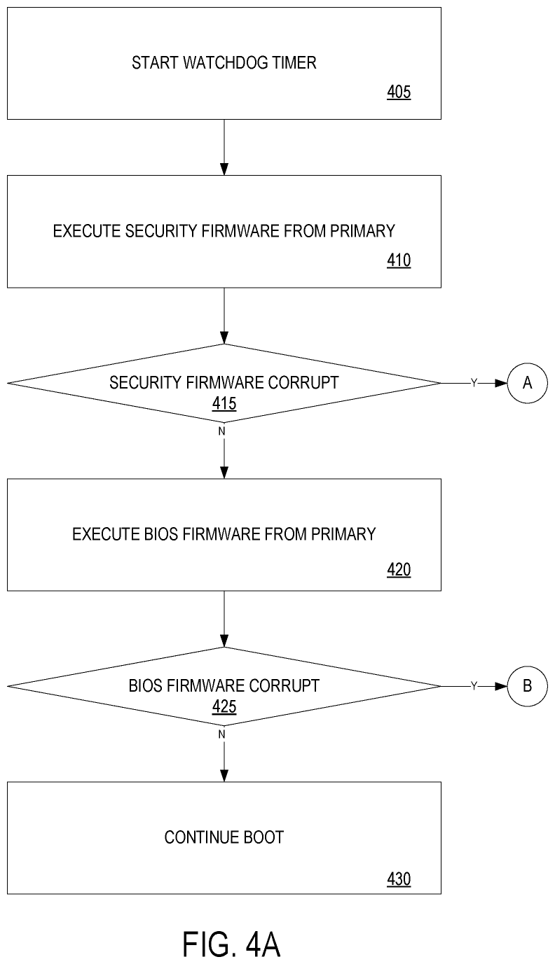

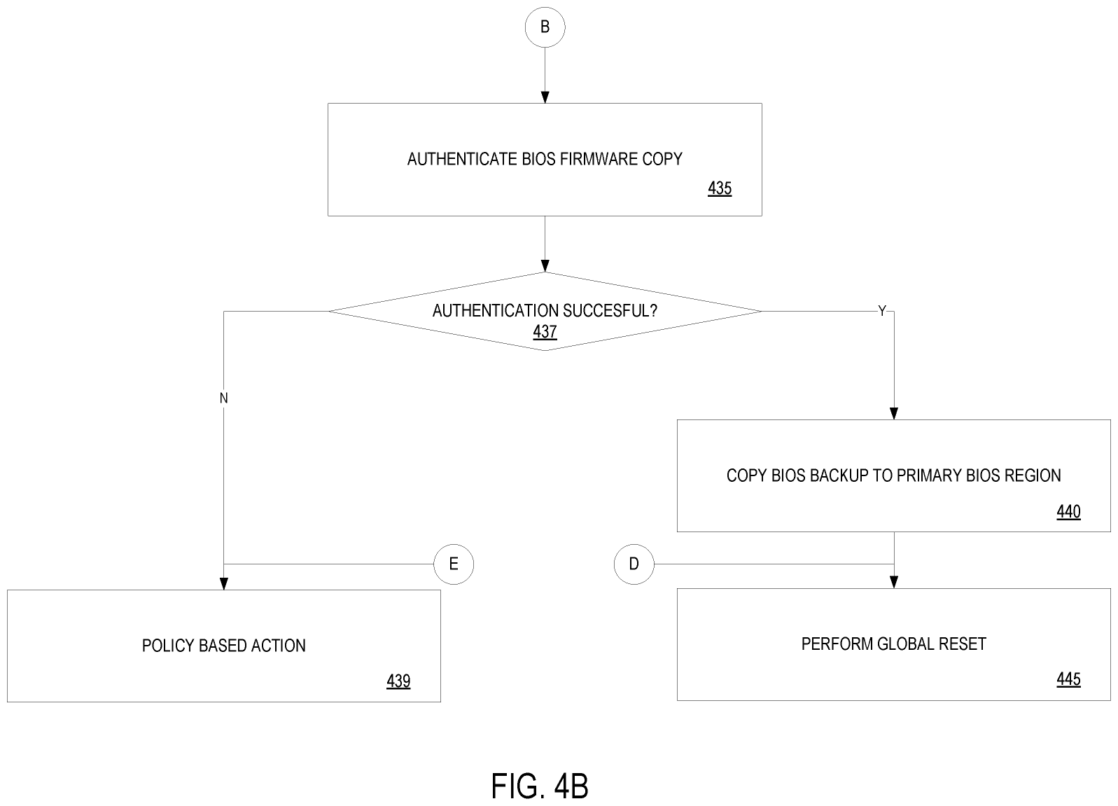

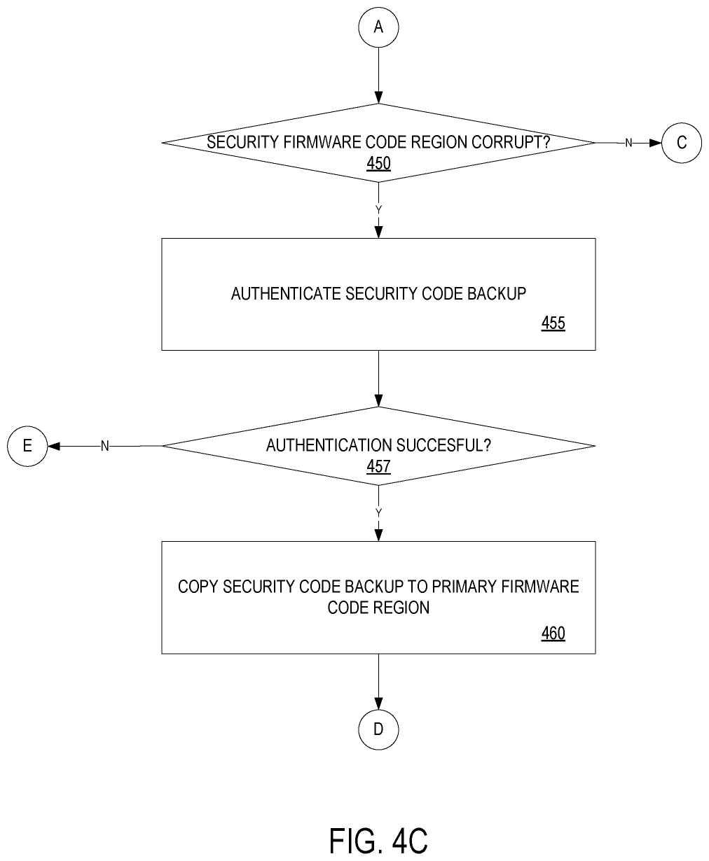

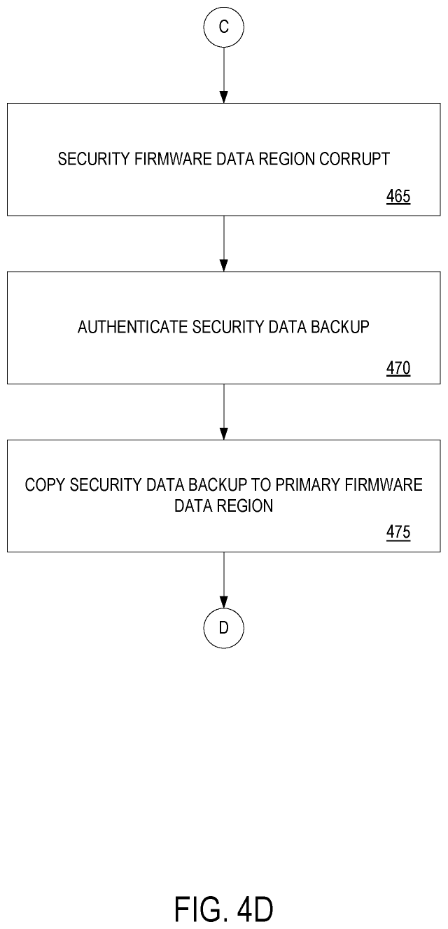

According to one embodiment, resiliency agent 330 performs an inspection of primary firmware 310 during a boot up process of platform 200 to determine whether primary firmware 310 has been detected. In such an embodiment, resiliency agent 330 initiates a recovery boot from secondary firmware storage 320 upon detecting that primary firmware 310 has been corrupted. FIGS. 4A-4D is a flow diagram illustrating one embodiment of a process performed by resiliency agent 330.

At processing block 405 (FIG. 4A), a watchdog timer is started. In one embodiment, the watchdog timer operates as a resiliency trigger that is armed by at Power On Reset and awaits a message from a host. Thus, the watchdog timer is armed and enabled prior to platform 200 firmware beginning execution. In one embodiment, the host messages are transmitted by BIOS starting from a BIOS initial boot block, which operates as a superset of all firmware failures in the system until that point.

At processing block 410, security firmware is loaded from primary firmware 310 and executed. In one embodiment, the security firmware comprises converged security engine (CSE) firmware that provides a root of trust for verification of platform 200. In such an embodiment, CSE firmware is verified by checking digital signatures (e.g., generated by a Rivest-Shamir-Adleman (RSA) algorithm). At decision block 415, a determination is made as to whether the security firmware has been corrupted.

Upon a determination at decision block 415 that the security firmware has not been corrupted, BIOS firmware is loaded from primary firmware 310 and executed, processing block 420. In the event that there is a system hang and BIOS does not respond with a message within the default configured time, the watchdog timer expires. In one embodiment, the system hang may occur anytime during the boot (e.g., even prior to BIOS boot). However, this missing event from the host is used as an overall synchronization point with the resiliency trigger.

At decision block 425, a determination is made as to whether the BIOS firmware has been corrupted, or the watchdog timer has expired. If not, the boot process is continued, processing block 430. However, upon a determination that firmware has been corrupted, or the watchdog timer has expired, the firmware copy stored in secondary firmware storage 320 is authenticated, processing block 435 (FIG. 4B). In one embodiment, resiliency agent 330 performs a verification process to authenticate the firmware copy.

At decision block 437, a determination is made as to whether the authentication is successful. Upon a determination of an authentication (or verification) failure of the firmware copy (e.g., due to a corruption or bug), a policy based action is performed at processing block 439. In one embodiment, the policy based action may comprise resiliency agent 330 repairing the firmware copy (e.g., using system fabric 205 or OOB side channel 301). In such an embodiment, a copy to recover the firmware copy (e.g., a second (or replacement) firmware copy) may be retrieved from a trusted source (e.g., by receiving the second firmware copy via WCE 312) and used to overwrite the corrupted firmware copy.

In a further embodiment, the second firmware copy may be received from a copy of a previous capsule update retained in Unified Extensible Firmware Interface (UEFI) firmware. Upon a determination at decision block 437 that the authentication of the firmware copy is successful, the authenticated firmware copy is copied to the BIOS region of primary firmware 310 at non-volatile memory 250 (e.g., via OOB side channel 301), processing block 440. At processing block 445, a global reset of platform 200 is performed.

Upon a determination at decision block 415 that the security firmware has been corrupted, a determination is made as to whether the security firmware code region is corrupt, decision block 450 (FIG. 4C). If so, the firmware copy of the security firmware code region is authenticated (e.g., via the verification process), processing block 455. At decision block 457, a determination is made as to whether the authentication is successful. If not, control is returned to processing block 439 (FIG. 4B) where a policy based action is taken. Otherwise, the authenticated firmware copy of the security code is copied to the firmware code region of primary firmware 310 at non-volatile memory 250, at processing block 460. Subsequently, control is returned to processing block 445 (FIG. 4B), where the global reset is performed.

Upon a determination at decision block 450 that the security firmware code region is not corrupt, it is determined that the security firmware data region is corrupt, processing block 465 (FIG. 4D). At processing block 470, the firmware copy of the security firmware data region is authenticated. At processing block 475, the authenticated firmware copy of the security data is copied to the firmware data region of primary firmware 310. Subsequently, control is returned to processing block 445 (FIG. 4B), where the global reset is performed.

The above-described mechanism reduces flash cost by moving a secondary resiliency copy of platform firmware to alternate block storage. Additionally, the mechanism provides secure storage of the resiliency firmware copy in a boot partition supported on the block storage. Further, side channel access to the resiliency firmware copy is provided to enable isolation of a recovery interface. If device and/or platform restrictions do not permit side channel access, the main channel may be used for Recovery with certain limitations.

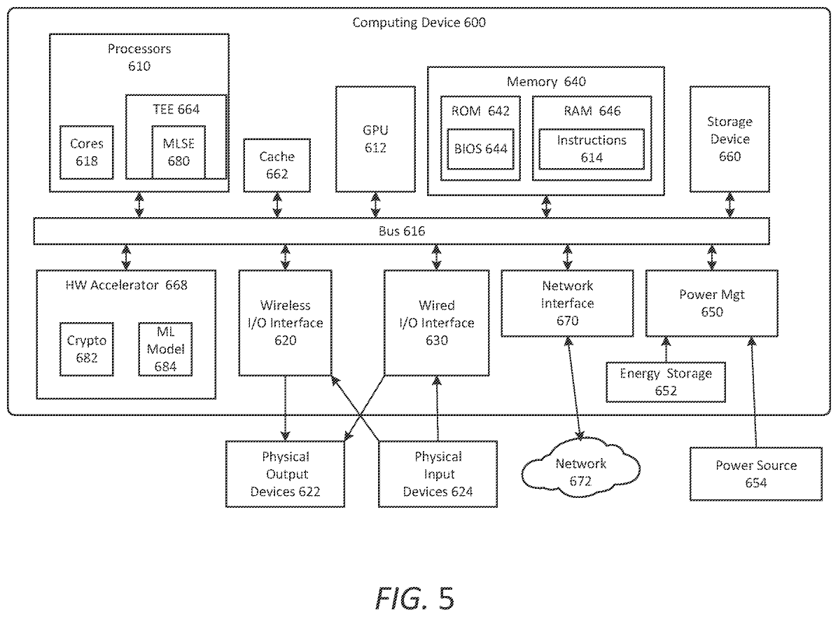

FIG. 5 is a schematic diagram of an illustrative electronic computing device to enable enhanced protection against adversarial attacks according to some embodiments. In some embodiments, the computing device 600 includes one or more processors 610 including one or more processors cores 618 and a TEE 664, the TEE including a machine learning service enclave (MLSE) 680. In some embodiments, the computing device 600 includes a hardware accelerator 668, the hardware accelerator including a cryptographic engine 682 and a machine learning model 684. In some embodiments, the computing device is to provide enhanced protections against ML adversarial attacks, as provided in FIGS. 1-4.

The computing device 600 may additionally include one or more of the following: cache 662, a graphical processing unit (GPU) 612 (which may be the hardware accelerator in some implementations), a wireless input/output (I/O) interface 620, a wired I/O interface 630, memory circuitry 640, power management circuitry 650, non-transitory storage device 660, and a network interface 670 for connection to a network 672. The following discussion provides a brief, general description of the components forming the illustrative computing device 600. Example, non-limiting computing devices 600 may include a desktop computing device, blade server device, workstation, or similar device or system.

In embodiments, the processor cores 618 are capable of executing machine-readable instruction sets 614, reading data and/or instruction sets 614 from one or more storage devices 660 and writing data to the one or more storage devices 660. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 618 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 600 includes a bus or similar communications link 616 that communicably couples and facilitates the exchange of information and/or data between various system components including the processor cores 618, the cache 662, the graphics processor circuitry 612, one or more wireless I/O interfaces 620, one or more wired I/O interfaces 630, one or more storage devices 660, and/or one or more network interfaces 670. The computing device 600 may be referred to in the singular herein, but this is not intended to limit the embodiments to a single computing device 600, since in certain embodiments, there may be more than one computing device 600 that incorporates, includes, or contains any number of communicably coupled, collocated, or remote networked circuits or devices.

The processor cores 618 may include any number, type, or combination of currently available or future developed devices capable of executing machine-readable instruction sets.

The processor cores 618 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 5 are of conventional design. Consequently, such blocks need not be described in further detail herein, as they will be understood by those skilled in the relevant art. The bus 616 that interconnects at least some of the components of the computing device 600 may employ any currently available or future developed serial or parallel bus structures or architectures.

The system memory 640 may include read-only memory (“ROM”) 642 and random access memory (“RAM”) 646. A portion of the ROM 642 may be used to store or otherwise retain a basic input/output system (“BIOS”) 644. The BIOS 644 provides basic functionality to the computing device 600, for example by causing the processor cores 618 to load and/or execute one or more machine-readable instruction sets 614. In embodiments, at least some of the one or more machine-readable instruction sets 614 cause at least a portion of the processor cores 618 to provide, create, produce, transition, and/or function as a dedicated, specific, and particular machine, for example a word processing machine, a digital image acquisition machine, a media playing machine, a gaming system, a communications device, a smartphone, or similar.

The computing device 600 may include at least one wireless input/output (I/O) interface 620. The at least one wireless I/O interface 620 may be communicably coupled to one or more physical output devices 622 (tactile devices, video displays, audio output devices, hardcopy output devices, etc.). The at least one wireless I/O interface 620 may communicably couple to one or more physical input devices 624 (pointing devices, touchscreens, keyboards, tactile devices, etc.). The at least one wireless I/O interface 620 may include any currently available or future developed wireless I/O interface. Example wireless I/O interfaces include, but are not limited to: BLUETOOTH®, near field communication (NFC), and similar.

The computing device 600 may include one or more wired input/output (I/O) interfaces 630. The at least one wired I/O interface 630 may be communicably coupled to one or more physical output devices 622 (tactile devices, video displays, audio output devices, hardcopy output devices, etc.). The at least one wired I/O interface 630 may be communicably coupled to one or more physical input devices 624 (pointing devices, touchscreens, keyboards, tactile devices, etc.). The wired I/O interface 630 may include any currently available or future developed I/O interface. Example wired I/O interfaces include, but are not limited to: universal serial bus (USB), IEEE 1394 (“FireWire”), and similar.

The computing device 600 may include one or more communicably coupled, non-transitory, data storage devices 660. The data storage devices 660 may include one or more hard disk drives (HDDs) and/or one or more solid-state storage devices (SSDs). The one or more data storage devices 660 may include any current or future developed storage appliances, network storage devices, and/or systems. Non-limiting examples of such data storage devices 660 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 660 may include one or more removable storage devices, such as one or more flash drives, flash memories, flash storage units, or similar appliances or devices capable of communicable coupling to and decoupling from the computing device 600.

The one or more data storage devices 660 may include interfaces or controllers (not shown) communicatively coupling the respective storage device or system to the bus 616. The one or more data storage devices 660 may store, retain, or otherwise contain machine-readable instruction sets, data structures, program modules, data stores, databases, logical structures, and/or other data useful to the processor cores 618 and/or graphics processor circuitry 612 and/or one or more applications executed on or by the processor cores 618 and/or graphics processor circuitry 612. In some instances, one or more data storage devices 660 may be communicably coupled to the processor cores 618, for example via the bus 616 or via one or more wired communications interfaces 630 (e.g., Universal Serial Bus or USB); one or more wireless communications interfaces 620 (e.g., Bluetooth®, Near Field Communication or NFC); and/or one or more network interfaces 670 (IEEE 802.3 or Ethernet, IEEE 802.11, or Wi-Fi®, etc.).

Processor-readable instruction sets 614 and other programs, applications, logic sets, and/or modules may be stored in whole or in part in the system memory 640. Such instruction sets 614 may be transferred, in whole or in part, from the one or more data storage devices 660. The instruction sets 614 may be loaded, stored, or otherwise retained in system memory 640, in whole or in part, during execution by the processor cores 618 and/or graphics processor circuitry 612.

The computing device 600 may include power management circuitry 650 that controls one or more operational aspects of the energy storage device 652. In embodiments, the energy storage device 652 may include one or more primary (i.e., non-rechargeable) or secondary (i.e., rechargeable) batteries or similar energy storage devices. In embodiments, the energy storage device 652 may include one or more supercapacitors or ultracapacitors. In embodiments, the power management circuitry 650 may alter, adjust, or control the flow of energy from an external power source 654 to the energy storage device 652 and/or to the computing device 600. The power source 654 may include, but is not limited to, a solar power system, a commercial electric grid, a portable generator, an external energy storage device, or any combination thereof.

For convenience, the processor cores 618, the graphics processor circuitry 612, the wireless I/O interface 620, the wired I/O interface 630, the storage device 660, and the network interface 670 are illustrated as communicatively coupled to each other via the bus 616, thereby providing connectivity between the above-described components. In alternative embodiments, the above-described components may be communicatively coupled in a different manner than illustrated in FIG. 5. For example, one or more of the above-described components may be directly coupled to other components, or may be coupled to each other, via one or more intermediary components (not shown). In another example, one or more of the above-described components may be integrated into the processor cores 618 and/or the graphics processor circuitry 612. In some embodiments, all or a portion of the bus 616 may be omitted and the components are coupled directly to each other using suitable wired or wireless connections.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

In various implementations, the computing device may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device may be any other electronic device that processes data or records data for processing elsewhere.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus to facilitate firmware resiliency in a computer system platform, comprising a first non-volatile memory to store primary firmware for a computer system platform, a second non-volatile memory to store a firmware copy of the primary firmware and a resiliency agent to detect unauthorized access to the primary firmware and restore the primary firmware stored in the first non-volatile memory with the firmware copy.

Example 2 includes the subject matter of Example 1, wherein the second non-volatile memory is isolated from first non-volatile memory.

Example 3 includes the subject matter of Examples 1 and 2, wherein the resiliency agent is coupled to the first non-volatile memory via a system fabric and coupled to the second non-volatile memory via the an out of band side channel.

Example 4 includes the subject matter of Examples 1-3, wherein the resiliency agent detects unauthorized access to the primary firmware during a boot process.

Example 5 includes the subject matter of Examples 1-4, wherein the resiliency agent initiates a recovery of the primary firmware upon detecting the unauthorized access to the primary firmware.

Example 6 includes the subject matter of Examples 1-5, wherein the resiliency agent performs the primary firmware recovery by retrieving the firmware copy from the second non-volatile memory via the out of band side channel.

Example 7 includes the subject matter of Examples 1-6, wherein the resiliency agent further performs the primary firmware recovery by overwriting the primary firmware with the firmware copy via the system fabric.

Example 8 includes the subject matter of Examples 1-7, wherein the resiliency agent further performs the primary firmware recovery by authenticating the firmware copy prior to overwriting the primary firmware.

Example 9 includes the subject matter of Examples 1-8, wherein the firmware copy is repaired upon not being able to authenticate the firmware copy.

Example 10 includes the subject matter of Examples 1-9, further comprising a Wireless Credentials Exchange (WCE) controller coupled to the second non-volatile memory via a radio frequency (RF) interface.

Example 11 includes the subject matter of Examples 1-10, wherein the WCE controller repairs the firmware copy via the RF interface.

Example 12 includes the subject matter of Examples 1-11, wherein the configuration policy comprises selecting a replacement firmware copy source from a source external to the computer system platform.

Some embodiments pertain to Example 13 that includes at least one computer readable medium having instructions stored thereon, which when executed by one or more processors, cause the processors to authenticate primary firmware stored in a first non-volatile memory in a computer system platform to determine whether the primary firmware has been corrupted detect a corruption of the primary firmware and initiate a recovery of the primary firmware upon detecting the corruption of the primary firmware, including restoring the primary firmware stored in the first non-volatile memory with a firmware copy stored in a second non-volatile memory in the computer system platform.

Example 14 includes the subject matter of Example 13, wherein the second non-volatile memory is isolated from first non-volatile memory.

Example 15 includes the subject matter of Examples 13 and 14, wherein the primary firmware recovery further comprises retrieving the firmware copy from the second non-volatile memory via an out of band side channel.

Example 16 includes the subject matter of Examples 13-15, wherein the primary firmware recovery further comprises overwriting the primary firmware with the firmware copy via a system fabric.

Example 17 includes the subject matter of Examples 13-16, wherein the primary firmware recovery further comprises authenticating the firmware copy prior to overwriting the primary firmware.

Some embodiments pertain to Example 18 that includes a method to facilitate firmware in a computing system, comprising authenticating primary firmware stored in a first non-volatile memory in a computer system platform to determine whether the primary firmware has been corrupted, detecting a corruption of the primary firmware and initiating a recovery of the primary firmware upon detecting the corruption of the primary firmware, including restoring the primary firmware stored in the first non-volatile memory with a firmware copy stored in a second non-volatile memory in the computer system platform.

Example 19 includes the subject matter of Example 18, wherein the second non-volatile memory is isolated from first non-volatile memory.

Example 20 includes the subject matter of Examples 18 and 19, wherein the primary firmware recovery further comprises retrieving the firmware copy from the second non-volatile memory via an out of band side channel.

Example 21 includes the subject matter of Examples 18-20, wherein the primary firmware recovery further comprises overwriting the primary firmware with the firmware copy via a system fabric.

Example 22 includes the subject matter of Examples 18-21, wherein the primary firmware recovery further comprises authenticating the firmware copy prior to overwriting the primary firmware.

The embodiments of the examples have been described above with reference to specific embodiments. Persons skilled in the art, however, will understand that various modifications and changes may be made thereto without departing from the broader spirit and scope as set forth in the appended claims. The foregoing description and drawings are, accordingly, to be regarded in an illustrative rather than a restrictive sense.

What is claimed is:

1. An apparatus to facilitate firmware resiliency in a computer system platform, comprising:
a first non-volatile memory to store primary firmware for a computer system platform;
a second non-volatile memory to store a firmware copy of the primary firmware; and
resiliency hardware to detect unauthorized access to the primary firmware and restore the primary firmware stored in the first non-volatile memory with the firmware copy.

2. The apparatus of claim 1, wherein the second non-volatile memory is isolated from first non-volatile memory.

3. The apparatus of claim 2, wherein the resiliency agent is coupled to the first non-volatile memory via a system fabric and coupled to the second non-volatile memory via the an out of band side channel.

4. The apparatus of claim 3, wherein the resiliency hardware detects unauthorized access to the primary firmware during a boot process.

5. The apparatus of claim 4, wherein the resiliency hardware initiates a recovery of the primary firmware upon detecting the unauthorized access to the primary firmware.

6. The apparatus of claim 5, wherein the resiliency hardware performs the primary firmware recovery by retrieving the firmware copy from the second non-volatile memory via the out of band side channel.

7. The apparatus of claim 6, wherein the resiliency hardware further performs the primary firmware recovery by overwriting the primary firmware with the firmware copy via the system fabric.

8. The apparatus of claim 7, wherein the resiliency hardware further performs the primary firmware recovery by authenticating the firmware copy prior to overwriting the primary firmware.

9. The apparatus of claim 8, wherein the firmware copy is repaired upon not being able to authenticate the firmware copy.

10. The apparatus of claim 9, further comprising a Wireless Credentials Exchange (WCE) controller coupled to the second non-volatile memory via a radio frequency (RF) interface.

11. The apparatus of claim 10, wherein the WCE controller repairs the firmware copy via the RF interface based on a configuration policy.

12. The apparatus of claim 11, wherein the configuration policy comprises selecting a replacement firmware copy source from a source external to the computer system platform.

13. At least one computer readable medium having instructions stored thereon, which when executed by one or more processors, cause the processors to:
authenticate primary firmware stored in a first non-volatile memory in a computer system platform to determine whether the primary firmware has been corrupted;
detect a corruption of the primary firmware; and
initiate a recovery of the primary firmware upon detecting the corruption of the primary firmware, including restoring the primary firmware stored in the first non-volatile memory with a firmware copy stored in a second non-volatile memory in the computer system platform.

14. The computer readable medium of claim 13, wherein the second non-volatile memory is isolated from first non-volatile memory.

15. The computer readable medium of claim 14, wherein the primary firmware recovery further comprises retrieving the firmware copy from the second non-volatile memory via an out of band side channel.

16. The computer readable medium of claim 15, wherein the primary firmware recovery further comprises overwriting the primary firmware with the firmware copy via a system fabric.

17. The computer readable medium of claim 16, wherein the primary firmware recovery further comprises authenticating the firmware copy prior to overwriting the primary firmware.

18. A method to facilitate firmware in a computing system, comprising:
authenticating primary firmware stored in a first non-volatile memory in a computer system platform to determine whether the primary firmware has been corrupted;
detecting a corruption of the primary firmware; and
initiating a recovery of the primary firmware upon detecting the corruption of the primary firmware, including restoring the primary firmware stored in the first non-volatile memory with a firmware copy stored in a second non-volatile memory in the computer system platform.

19. The method of claim 18, wherein the second non-volatile memory is isolated from first non-volatile memory.

20. The method of claim 19, wherein the primary firmware recovery further comprises retrieving the firmware copy from the second non-volatile memory via an out of band side channel.

21. The method of claim 20, wherein the primary firmware recovery further comprises overwriting the primary firmware with the firmware copy via a system fabric.

22. The method of claim 21, wherein the primary firmware recovery further comprises authenticating the firmware copy prior to overwriting the primary firmware.
